(19) United States
(12) Patent Application Publication
(10) Pub. No.: US 2006/0197715 A1
(43) Pub. Date: Sep. 7, 2006

(54) Information apparatus and display control method

(75) Inventor: Toshikazu Morisawa, Tokorozawa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/358,974

(22) Filed: Feb. 21, 2006

(30) Foreign Application Priority Data
Mar. 1, 2005 (JP) 2005-056601

(51) Int. Cl. G09G 5/00

(52) U.S. Cl. 345/1.1

(57) ABSTRACT

According to one embodiment, an information apparatus comprises a body, a cover capable of being opened and closed with respect to the body, a first display unit provided in the cover, a second display unit capable of displaying information regardless of whether the cover is opened or closed with respect to the body, and a mechanism allowing the second display unit to move to a position in which a screen of the second display unit is visible to a user when the cover is opened.

### CROSS-REFERENCE TO RELATED APPLICATIONS

This application is based upon and claims the benefit of priority from Japanese Patent Application No. 2005-056601, filed Mar. 1, 2005, the entire contents of which are incorporated herein by reference.

### BACKGROUND

1. Field

One embodiment of the invention relates to an information apparatus having a display unit and an auxiliary display unit, and a display control method.

2. Description of the Related Art

An information apparatus, such as a notebook computer, is generally equipped with a cover, which is capable of being opened and closed with respect to the main body of the information apparatus. The cover includes a display unit to display information. Some type of the information apparatus has an auxiliary display unit in addition to the above-mentioned display unit, for example, in a front portion of the main body, to display a condition of the power source or the like of the information apparatus. The auxiliary display unit may be provided in the cover. It is well known that the auxiliary display unit is provided in a required part of the information apparatus.

For example, Jpn. Pat. Appln. KOKAI Publication No. 2003-263239 (hereinafter referred to as Document 1) discloses an information apparatus, which includes a first housing provided with a first display section, and a second housing having a second display section. The second housing is connected to the first housing by a movable support member. Furthermore, U.S. Pat. No. 6,222,507 (hereinafter referred to as Document 2) discloses a multi-screen personal computer, which has two sub-screens in addition to a main screen.

In the case where the auxiliary display unit is formed in a front portion of the main body, it must be arranged in a limited area of the information apparatus. Therefore, the size of the display is inevitably small, and only limited contents can be displayed. On the other hand, if the auxiliary display unit is formed in the cover of the information apparatus, the size thereof can be relatively large. However, since the auxiliary display unit is not visible to a user while the cover is opened, it cannot be effectively utilized.

The information apparatuses disclosed in Documents 1 and 2 do not have a structure in which the cover having the main display unit can be opened and closed with respect to the main body of the information apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a first example of placement and mechanism of an auxiliary display unit in information apparatus according to an embodiment of the invention;

FIG. 2 is an exemplary diagram showing a second example of placement and mechanism of an auxiliary display unit in the information apparatus according to the embodiment of the invention;

FIGS. 3A, 3B, 3C and 3D are an exemplary diagrams showing side views for explaining detailed movement of the mechanism of the information apparatus in the second example;

FIG. 4 is an exemplary diagram showing a third example of placement and mechanism of an auxiliary display unit in the information apparatus according to the embodiment of the invention;

FIG. 5 is an exemplary block diagram showing a configuration of the information apparatus;

FIG. 6 is an exemplary diagram showing an example of setting information relating to display control for use in a control unit or a sub-CPU;

FIG. 7 is an exemplary diagram showing an example of setting information relating to power control for use in the control unit or the sub-CPU;

FIG. 8 is an exemplary flowchart for explaining an operation relating to presetting; and

FIG. 9 is an exemplary flowchart for explaining an operation relating to setting based on set information.

### DETAILED DESCRIPTION

Various embodiments according to the invention will be described hereinafter with reference to the accompanying drawings. In general, according to one embodiment of the invention, an information apparatus comprises a body, a cover capable of being opened and closed with respect to the body, a first display unit provided in the cover, a second display unit capable of displaying information regardless of whether the cover is opened or closed with respect to the body, and a mechanism allowing the second display unit to move to a position in which a screen of the second display unit is visible to a user when the cover is opened.

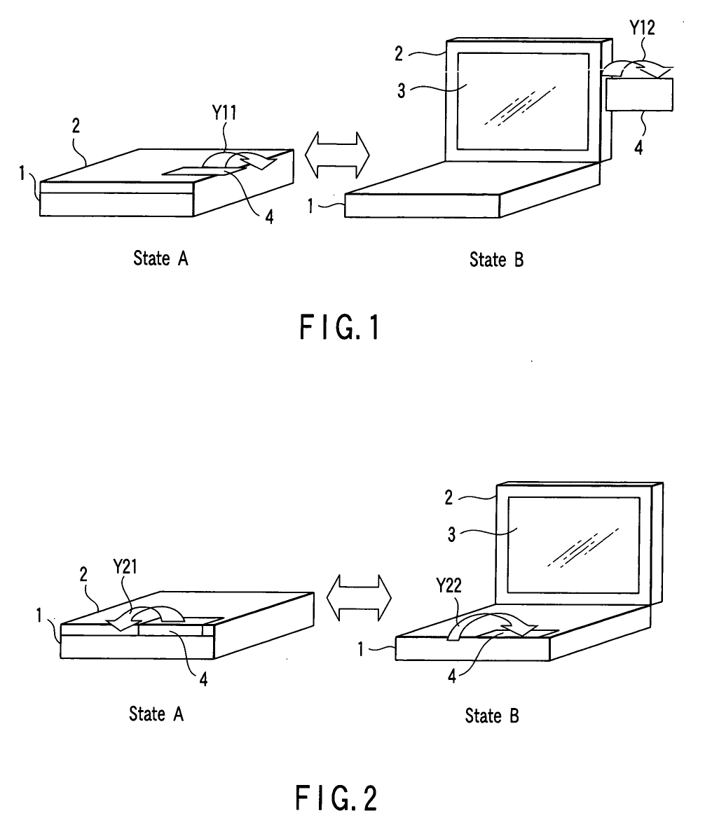

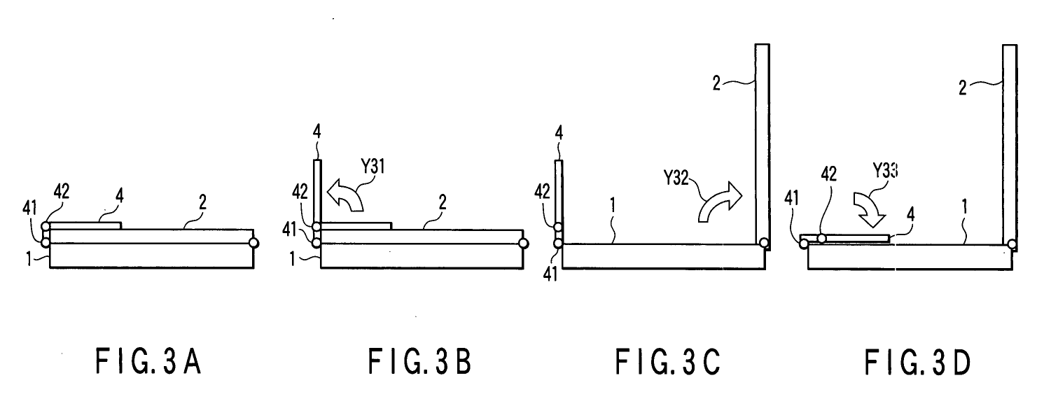

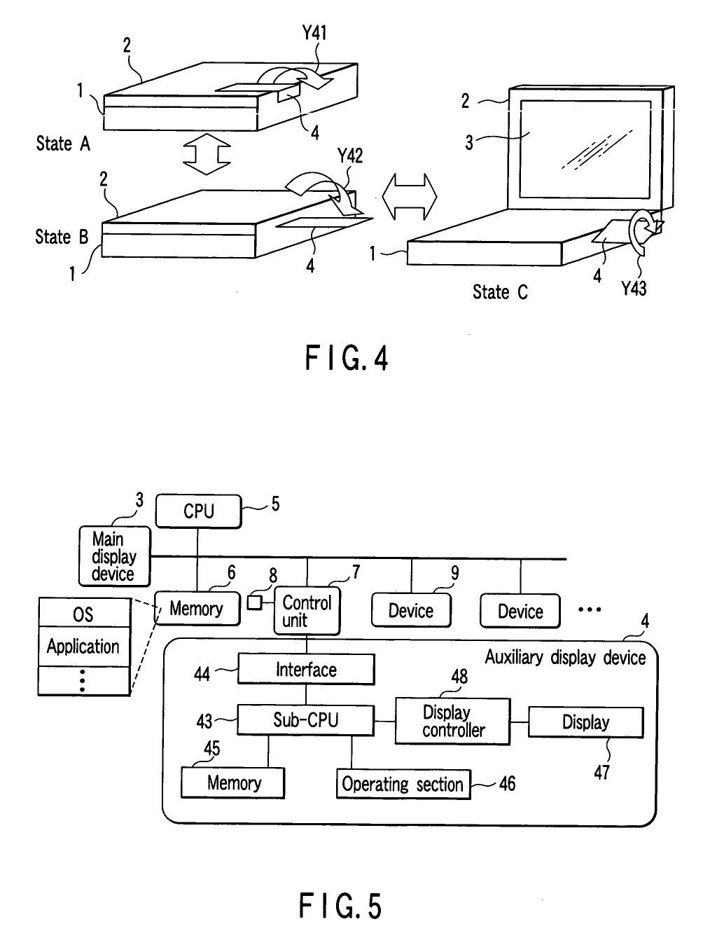

First, three examples of placement and mechanism of an auxiliary display unit in the information apparatus according to the embodiment of the invention will be described with reference to FIGS. 1 to 4. FIG. 1 shows the first example, FIGS. 2, 3A, 3B, 3C and 3D show the second example and FIG. 4 shows the third example.

The information apparatus shown in FIGS. 1 to 4 is, for example, a notebook computer, which has a main body 1 and a cover 2. The cover 2 includes a main display unit (main LCD) 3 and is capable of being opened and closed with respect to the main body 1. An auxiliary display unit (sub-LCD) 4 is connected to an end portion of the main body 1 or the cover 2 by a hinge mechanism attached to an end of the device 4. The hinge mechanism allows the auxiliary display unit 4 to move to a position in which the screen thereof is visible to a user, when the user opens the cover 2.

In this embodiment, it is assumed that the operating system of the information apparatus is running, regardless of whether the cover 2 is opened or closed, and that the auxiliary display unit 4 displays information obtained while the operating system is running. In short, the auxiliary display unit 4 is capable of displaying information regardless of whether the cover is opened or closed.

In the first example shown in FIG. 1, the auxiliary display unit 4 is laid on the upper surface of the cover 2, and the hinge mechanism is connected to an end of a side surface of the cover 2. In the state A shown in FIG. 1, the screen of the auxiliary display unit 4 faces up and is visible to the user. When the user is going to open the cover 2, he or she turns the auxiliary display unit 4 about the axis of the hinge mechanism by about 180 degrees, as indicated by the arrow Y11. In the state B shown in FIG. 1, the cover 2 is opened. Since the auxiliary display unit 4 has been turned as indicated by the arrow Y12, the user can see the screen.

In the second example shown in FIG. 2, the auxiliary display unit 4 is laid on the upper surface of the cover 2, and the hinge mechanism is connected to an end of a front surface of the main body 1. In the state A shown in FIG. 2, the screen of the auxiliary display unit 4 faces up and is visible to the user. When the user is going to open the cover 2, he or she turns (raise) the auxiliary display unit 4 about the axis of the hinge mechanism by about 90 degrees, as indicated by the arrow Y21. In the state B shown in FIG. 2, the cover 2 is opened. The user turns the auxiliary display unit 4 as indicated by the arrow Y22, and places it on the upper surface of the main body. As a result, the user can see the screen of the auxiliary display unit 4.

Movement of the mechanism of the information apparatus in the second example will be more detailed with reference to the side views shown in FIGS. 3A, 3B, 3C and 3D. The auxiliary display unit 4 has hinge portions 41 and 42, which allow rotational movements of members. The auxiliary display unit 4 is attached to the main body 1 with the hinge portion 41, and is bendable by means of the hinge portion 42.

FIG. 3A shows the state in which the auxiliary display unit 4 is turned about the hinge portion 42 and laid on the upper surface of the cover 2. FIG. 3B shows the state in which the auxiliary display unit is turned (raised) as indicated by the arrow Y31 through the operation by the user, so that the cover 2 is capable of being opened. FIG. 3C shows the state in which the cover 2 is opened by the operator as indicated by the arrow Y32. FIG. 3D shows the state in which the auxiliary display unit 4 as a whole is turned about the hinge portion 41 and laid on the upper surface of the main body 1.

In the third example shown in FIG. 4, the auxiliary display unit 4 is laid the upper surface of the cover 2, and the hinge mechanism is connected to an end of a side surface of the main body 1. In the state A shown in FIG. 4, the screen of the auxiliary display unit 4 faces up and is visible to the user. When the user is going to open the cover 2, he or she turns the auxiliary display unit 4 about the axis of the hinge mechanism by about 180 degrees, as indicated by the arrow Y41. In this state, the screen of the auxiliary display unit 4 faces down, and the user cannot see it. In the state C shown in FIG. 4, the cover 2 is opened. The user turns the auxiliary display unit 4 by about 180 degrees as indicated by the arrow Y43, so that the screen of the auxiliary display unit 4 faces up. As a result, the user can see the screen of the auxiliary display unit 4.

FIG. 5 is an exemplary block diagram showing a configuration of the above the information apparatus. In FIG. 5, the same elements as those shown in FIGS. 1 to 4 are identified by the same reference numerals as used in FIGS. 1 to 4.

In addition to the main display unit 3 and the auxiliary display unit 4 described above, the information apparatus includes a CPU 5, a memory 6, a control unit 7, an operating unit 8, a device 9, etc. The auxiliary display unit 4 includes a sub-CPU 43, an interface 44, a memory 45, an operating section 46, a display 47, a display controller 48, etc.

The CPU 5 controls the overall operation of the information apparatus. It executes programs resident in, for example, the memory 6, thereby performing various display control and power control with respect to the main display unit 3 and the auxiliary display unit 4.

The memory 6 is a non-volatile memory, which stores the operating system (OS), various applications (software for email, etc.) and drivers.

The control unit 7 is a control device, which manages power supply and displays. When the control unit 7 detects depression of any of various operation buttons, including the power supply button, it performs a setting process or a setting change process relating to the power supply condition and the display contents of the main display unit 3 and the auxiliary display unit 4 based on the setting information preset in a register or the like. It also performs a process for storing necessary information, an information reading process, a transfer process, a resetting process, etc., when a rebooting, suspending or resuming process is performed. The control unit 7 also performs control to cause the auxiliary display unit 4 to display information (contents of received mail, etc.), which is obtained from the main body side while the OS is running. Further, when the rebooting is carried out by restarting the OS, the control unit 7 also performs control to cause the auxiliary display unit 4 to display information, which is obtained from the main body side. Furthermore, the control unit 7 performs a refresh operation in response to an instruction from the auxiliary display unit 4.

The operating unit 8 has a power supply button to instruct a power on/off operation of the main body, an operation button to instruct a refreshing operation (including a refreshing operation or sync operation relating to the power supply condition or the display contents of the auxiliary display unit 4), operation buttons to instruct changing of the setting conditions respectively relating to the power supply condition and the display contents of the main display unit 3 and the auxiliary display unit 4.

The device 9 is a communication device or the like, which is connected to a system bus and is capable of communicating with another apparatus.

The sub-CPU 43 controls the operations of the auxiliary display unit 4. Through an interface 44, the sub-CPU 43 communicates with the control unit 7: it obtains various information (the contents of received email, the number of received email items, the amount of electricity remaining in the battery, the wireless signal level, the date and time, etc.) from the main body side, and sends a refreshing instruction to the main body side. Further, when the sub-CPU 43 detects a signal from the operating section 46, it performs a setting process or a setting change process relating to the power supply condition and the display contents of the auxiliary display unit 4 based on the setting information preset in the memory 45 or the like.

The interface 44 performs an interface process between the sub-CPU 43 and the control unit 7 of the main body side.

The memory 45 stores setting information relating to the power supply condition and the display contents of the auxiliary display unit 4 or a display 47.

The operating section 46 has a power supply button to instruct a power on/off operation of the auxiliary display unit 4, an operation button to instruct a refreshing operation or sync operation relating to the power supply condition or the display contents of the auxiliary display unit 4, operation buttons to instruct changing of the setting conditions respectively relating to the power supply condition and the display contents, etc. of the auxiliary display unit 4. The operating section 46 may be provided in the form of a touch pad on a surface of a main body of the auxiliary display unit 4.

The display 47 displays information in accordance with instructions from a display controller 48.

The display controller 48 performs display control with respect to the display 47.

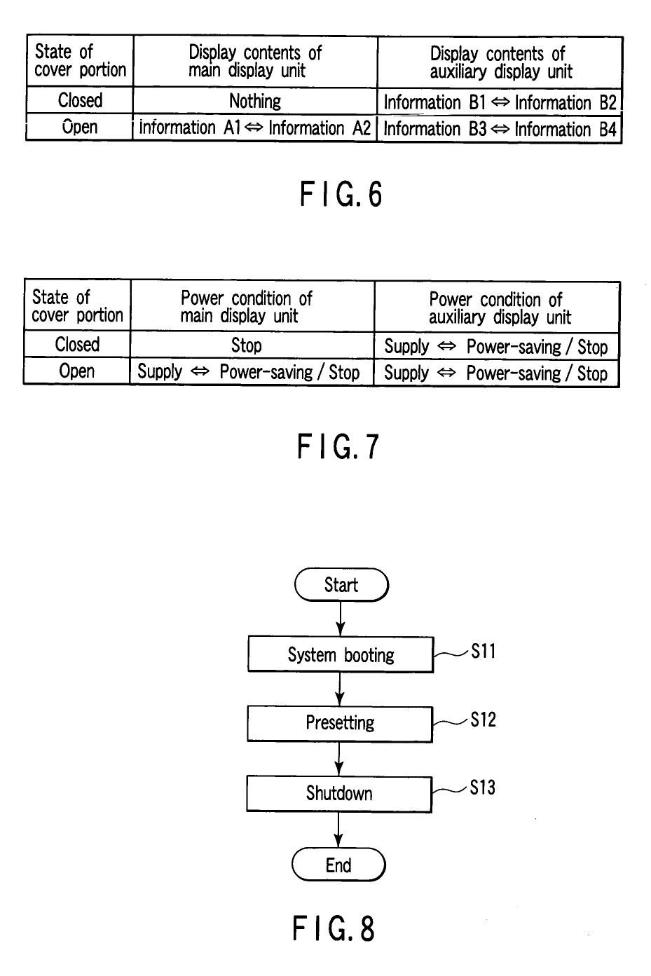

FIG. 6 is an exemplary diagram showing an example of setting information relating to display control for use in the control unit 7 or the sub-CPU 43. The setting information can be preset by the user through the control unit 7 or the sub-CPU 43.

While the cover 2 is closed, the main display unit 3 displays nothing, and the auxiliary display unit 4 displays, for example, information B1. In this state, if the user operates the operation button to change the display contents of the auxiliary display unit 4, the information B1 is changed to another information: for example, information B2.

The information B1 and B2 may be, for example, the contents of received email, the number of received email items, the amount of electricity remaining in the battery, the wireless signal level relating to WiFi (Wireless Fidelity) or the like, or the date and time. The information B1 and B2 may be all or part of display information that should be displayed in the main display unit 3 (e.g., a desktop screen on which icons are arranged, schedules and a slide show), or a reduced image of such information (a thumbnail image or the like). Further, the information B1 and B2 may be obtained while the OS is either running or stopped.

On the other hand, while the cover 2 is opened, the main display unit 3 displays, for example, information Al and the auxiliary display unit 4 displays, for example, information B3. In this state, if the user performs an operation to change the display contents of the main display unit 3, the information A1 is changed to another information, for example, information A2. Of course, it is possible to return the display contents to the original state through an operation by the user. If the user performs an operation to change the display contents of the auxiliary display unit 4, the information B3 is changed to another information: for example, information B4. Of course, it is possible to return the display contents to the original state through an operation by the user.

The information A1 and A2 may be, for example, information obtained from various applications that operate under the OS. The information B3 and B4 may be extension of the display contents of the main display unit 3, so that the display of the auxiliary display unit 4 is capable of functioning as an extended display area of the display of the main display unit 3. In this case, both the main display unit 3 and the auxiliary display unit 4 display information provided by the same application.

The information B3 and B4 may be all or part of display information that should be displayed in the main display unit 3 (e.g., a desktop screen on which icons are arranged, schedules and a slide show), or a reduced image of such information (a thumbnail image or the like). In this case, the application, which should be provided for the display in the main display unit 3, is provided for the auxiliary display unit 4, and the information provided by the application is displayed on the auxiliary display unit 4. Alternatively, the information B3 and B4 may be completely the same as the above-mentioned information B1 and B2. Further, it may be obtained while the OS is either running or stopped.

FIG. 7 is an exemplary diagram showing an example of setting information relating to power control for use in the control unit 7 or the sub-CPU 43. The setting information can be preset by the user through the control unit 7 or the sub-CPU 43.

While the cover 2 is closed, power is not supplied to the main display unit 3 (or the display thereof), but supplied to the auxiliary display unit 4 (or the display thereof). In this state, if the user performs an operation to change the power supply condition of the auxiliary display unit 4 to a power-saving mode or a power-stop mode, the auxiliary display unit 4 (or the display thereof) is changed to the power-saving mode or the power-stop mode. Of course, it is possible to return the power supply condition to the original state through an operation by the user.

On the other hand, while the cover 2 is opened, power is supplied to both the main display unit 3 (or the display thereof) and the auxiliary display unit 4 (or the display thereof). In this state, if the user performs an operation to change the power supply condition of the main display unit 3 to the power-saving mode or the power-stop mode, the main display unit 3 (or the display thereof) is changed to the power-saving mode or the power-stop mode. Of course, it is possible to return the power supply condition to the original state through an operation of the user. If the user performs an operation to change the power supply condition of the auxiliary display unit 4 to the power-saving mode or the power-stop mode, the auxiliary display unit 4 (or the display thereof) is changed to the power-saving mode or the power-stop mode. Of course, it is possible to return the power supply condition to the original state through an operation by the user.

Operations relating to presetting will now be described with reference to FIG. 8.

The user operates the power supply button or the like, so that the information apparatus is powered on and the OS on the main body side is booted (block S11).

The user causes the main display unit 3 on the main body side to display a setting screen (the contents corresponding to FIGS. 6 and 7), and determines setting contents, thereby carrying out presetting (block S12). The contents of the presetting are stored in a predetermined register or the like.

When the user performs a shutdown operation, a shutdown process is performed (block S13).

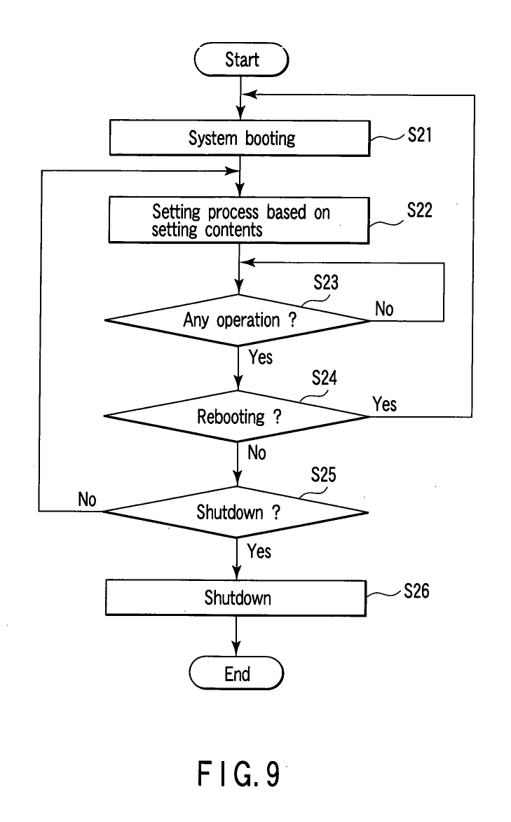

Operations relating to setting will be described with reference to FIG. 9. It is assumed that the presetting shown in FIG. 8 has been completed.

The user operates the power supply button or the like, so that the information apparatus is powered on and the OS on the main body side is booted (block S21).

The main display unit 3 and the auxiliary display unit 4 perform setting operations relating to the power supply condition and the display contents based on the contents of the pre-stored setting information (block S22).

Then, it is determined whether or not the user performs any operation (block S23). If any operation is detected (Yes in block S23) and if the operation corresponds to rebooting (Yes in block S24), the process returns to block S21. If the operation corresponds to neither rebooting nor shutdown (No in block S25), it is determined that a resetting process is required and the process returns to block S22. If the operation corresponds to shutdown (Yes in block S25), the shutdown operation is executed (block S26).

As described above, according to the embodiment, even if the cover is opened, the screen of the auxiliary display unit is easily visible to the user. Further, the main display unit and the auxiliary display unit are capable of displaying desired information upon request by the user, and power consumed by an unnecessary display unit can be saved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.
What is claimed is:

1. An information apparatus, comprising:
a body;
a cover capable of being opened and closed with respect to the body;
a first display unit provided in the cover;
a second display unit capable of displaying information regardless of whether the cover is opened or closed with respect to the body; and
a mechanism allowing the second display unit to move to a position in which a screen of the second display unit is visible to a user when the cover is opened.

2. The information apparatus according to claim 1, wherein the mechanism is a hinge mechanism, which is attached between the cover and the second display unit, and configured to rotate the second display unit with respect to the cover.

3. The information apparatus according to claim 1, wherein the mechanism is a hinge mechanism, which is attached between the body and the second display unit, and configured to rotate the second display unit with respect to the body.

4. The information apparatus according to claim 1, wherein the mechanism is a hinge mechanism, which is attached between the body and the second display unit, and configured to rotate the second display unit with respect to the body in one direction and in another direction.

5. The information apparatus according to claim 1, wherein an operating system in the body is running while the cover is closed with respect to the body, and the information apparatus further comprising a controller which causes the second display unit to display information obtained while the operating system is running.

6. The information apparatus according to claim 1, wherein an operating system in the body is rebooted when a predetermined operation is performed while the cover is closed with respect to the body, and the information apparatus further comprising a controller which causes the second display unit to display information obtained while the operating system is being rebooted.

7. A display control method applied to an information apparatus including a body, a cover capable of being opened and closed with respect to the body, a first display unit provided in the cover, and a second display unit capable of displaying information regardless of whether the cover is opened or closed with respect to the body, the method comprising:
causing the second display unit to display first information while the cover is closed; and
causing the second display unit to display second information, which is different from the first information, while the cover is opened.

8. The display control method according to claim 7, further comprising setting the first information and the second information to be displayed in the second display unit.

9. The display control method according to claim 7, further comprising changing the first information displayed in the second display unit to another information when a predetermined operation is performed while the cover is closed.

10. The display control method according to claim 7, further comprising changing the second information displayed in the second display unit to another information when a predetermined operation is performed while the cover is opened.

11. The display control method according to claim 7, wherein the first information and the second information is obtained while an operating system in the information apparatus is running.

12. The display control method according to claim 7, further comprising causing the first display unit and the second display unit to display information provided by same application while the cover is opened.

13. A display control method applied to an information apparatus including a body, a cover capable of being opened and closed with respect to the body, a first display unit provided in the cover, and a second display unit capable of displaying information regardless of whether the cover is opened or closed with respect to the body, the method comprising:
stopping power supply to the first display unit and supplying power to the second display unit, while the cover is closed with respect to the body;
supplying power to the first display unit and the second display unit, while the cover is opened with respect to the body; and
stopping power supply to the first display unit or the second display unit, when a predetermined operation is performed while the cover is opened with respect to the body.

14. The display control method according to claim 13, further comprising setting whether power is to be supplied to the second display unit while the cover is closed.

15. The display control method according to claim 13, further comprising setting whether power is to be supplied to the second display unit while the cover is opened.

16. The display control method according to claim 13, further comprising stopping power supply to the second display unit, when a predetermined operation is performed while the cover is closed.
